(19) United States
(12) Patent Application Publication
(10) Pub. No.: US 2006/0269189 A1
(43) Pub. Date: Nov. 30, 2006

(54) Backlight assembly and liquid crystal display having the same

(75) Inventor: Jeong-min Seo, Seongnam-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/444,607

(22) Filed: May 31, 2006

(30) Foreign Application Priority Data
May 31, 2005 (KR) 10-2005-0046316

(51) Int. Cl. G02B 6/26

(52) U.S. Cl. 385/39

(57) ABSTRACT

A backlight assembly which realizes a lighter, thinner, shorter and smaller LCD while minimizing light loss. and a liquid crystal display having the same are provided. The backlight assembly includes a lamp assembly providing light to a liquid crystal panel, a light guide film guiding the light emitted from the lamp assembly, a light guide for guiding the light emitted from the lamp assembly to the light guide film through a gap, optical sheets stacked on the light guide film for diffusing and condensing the light emitted from the light guide film, and upper and lower receiving containers for receiving the lamp assembly, the light guide film, and the optical sheets.

### CROSS-REFERENCE TO RELATED APPLICATIONS

This application claims priority from Korean Patent Application No. 10-2005-0046316 filed on May 31, 2005 in the Korean Intellectual Property Office, the disclosure of which is incorporated herein by reference in its entirety.

### BACKGROUND OF THE INVENTION

1. Field of the Invention

The present invention relates to a display device, and more particularly, to a backlight assembly and a liquid crystal display (LCD) having the same.

2. Description of the Related Art

Cathode ray tubes (CRTs) are conventionally used in monitors such as instrumentation devices or information terminal devices including televisions (TVs). However, due to the weight and size of CRTs, CRTs are not well suited to the demand for miniaturization and lightness of electronic products.

To substitute CRTs, LCDs have been actively researched. LCDs have some notable advantages, such as small size, light weight, low power consumption and low driving voltages, and are capable of displaying information using electrical and optical properties of liquid crystals injected into a liquid crystal panel. Due to such advantages, LCDs are being actively researched and developed. Recently, LCDs have become the mainstream of the current flat display devices and are used in a wide variety of applications, such as portable computers, desktop computer monitors, monitors of high-quality image display devices, and the like.

LCDs are generally classified into two types according to the liquid crystal used: a twisted nematic (TN) type; and a super-twisted nematic (STN) type. These LCDs are also classified into an active matrix display type using switching devices and TN liquid crystal, and a passive matrix display type using STN liquid crystal according to a difference in the driving method.

The two types of LCDs have noticeable differences. The active matrix display is employed in TFT-LCDs utilizing thin film transistors (TFT) as the switching element. The passive matrix display does not utilize TFT as the switching element. In other words, the passive matrix display does not need complicated circuits such as TFTs. With the recent proliferation of portable computers, TFT-LCDs are widely used.

A typical liquid panel assembly includes a liquid crystal panel having two panels, e.g., a TFT panel and a color filter panel, a liquid crystal material having dielectric anisotropy interposed between the two panels, a driving IC for applying driving signals to gate lines and data lines mounted on the liquid crystal panel by a chip on glass (CPG) method, and a flexible printed circuit board (PCB) for connecting the driving IC with an external PCB transmitting predetermined data and control signals. The liquid panel assembly is received in a backlight assembly, forming an LCD. The backlight assembly includes a light guide panel, a lamp assembly, and various optical sheets.

In conventional LCDs, the thickness of a light guide panel is subject to the thickness of a lamp assembly. For example, when a light emitting diode (LED) is used as a lamp assembly in a small-sized LCD, the thickness of the light guide panel is designed to be substantially the same as that of the LED so as to maximize the efficiency of light transmitted to the light guide panel from the lamp assembly and to prevent light leakage.

As lighter, thinner, shorter and smaller LCDs have recently undergone a remarkable market expansion, it is desirable that light guide panels have a smaller thickness. However, if a light guide panel is thinner than a lamp assembly, there may be light leakage due to a difference in thickness between the lamp assembly and the light guide panel.

### SUMMARY OF THE INVENTION

The present invention provides a lighter, thinner, shorter and smaller backlight assembly while reducing light loss. The present invention also provides a liquid crystal display (LCD) having the backlight assembly.

The above stated object as well as other objects, features and advantages, of the present invention will become clear to those skilled in the art upon review of the following description.

According to an aspect of the present invention, there is provided a backlight assembly including a lamp assembly, a light guide film, a light guide, optical sheets, and upper and lower receiving containers.

According to another aspect of the present invention, there is provided a backlight assembly including a lamp assembly providing light to a liquid crystal panel, a light guide film for guiding the light emitted from the lamp assembly, a reflection cover covering an upper portion of an air gap between the lamp assembly and the light guide film for reflecting light emitted from the lamp assembly into the light guide film, optical sheets stacked on the light guide film for diffusing and condensing the light emitted from the light guide film, and upper and lower receiving containers for receiving the lamp assembly, the light guide film, and the optical sheets.

According to still another aspect of the present invention, there is provided a backlight assembly including a lamp assembly providing light to a liquid crystal panel, a light guide panel for guiding the light emitted from the lamp assembly, a light guide gel interposed in an air gap between the lamp assembly and the light guide panel for guiding the light emitted from the lamp assembly to the light guide panel, a reflection cover covering an upper portion of the light guide gel and reflecting light emitted from the lamp assembly into the light guide panel, optical sheets stacked on the light guide panel for diffusing and condensing the light emitted from the light guide film, and upper and lower receiving containers for receiving the lamp assembly, the light guide panel, and the optical sheets.

According to a further aspect of the present invention, there is provided a liquid crystal display including a liquid crystal panel assembly displaying image information, and a backlight assembly as described above providing light to the liquid crystal panel assembly.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view of a liquid crystal display (LCD) according to an embodiment of the present invention;

FIG. 2 is a perspective view of the LCD of FIG. 1 after assembly;

FIG. 3 is a cross-sectional view taken along line A-A′ of FIG. 2;

FIG. 4 is a perspective view of a lamp assembly having a plurality of point sources of light, a light guide film, and a reflection cover;

FIG. 5 is a cross-sectional view of a backlight assembly according to another embodiment of the present invention; and

FIG. 6 is a cross-sectional view of a backlight assembly according to another embodiment of the present invention.

Embodiments of the present invention and their advantages are best understood by referring to the detailed description that follows. It should be appreciated that like reference numerals are used to identify like elements illustrated in one or more of the figures. It should also be appreciated that the figures may not be necessarily drawn to scale.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will convey the concept of the invention to those skilled in the art, and the present invention will only be defined by the appended claims. Like reference numerals refer to like elements throughout the specification.

A liquid crystal display (LCD) according to the present invention may include a portable multimedia player (PMP), a personal digital assistant (PDA), a portable digital versatile disk (DVD) player, a cellular phone, and so on. For the convenience of explanation, the LCD according to the present invention including a cellular phone will now be described. However, the present invention is not limited to this embodiment and may include the above-mentioned LCDs.

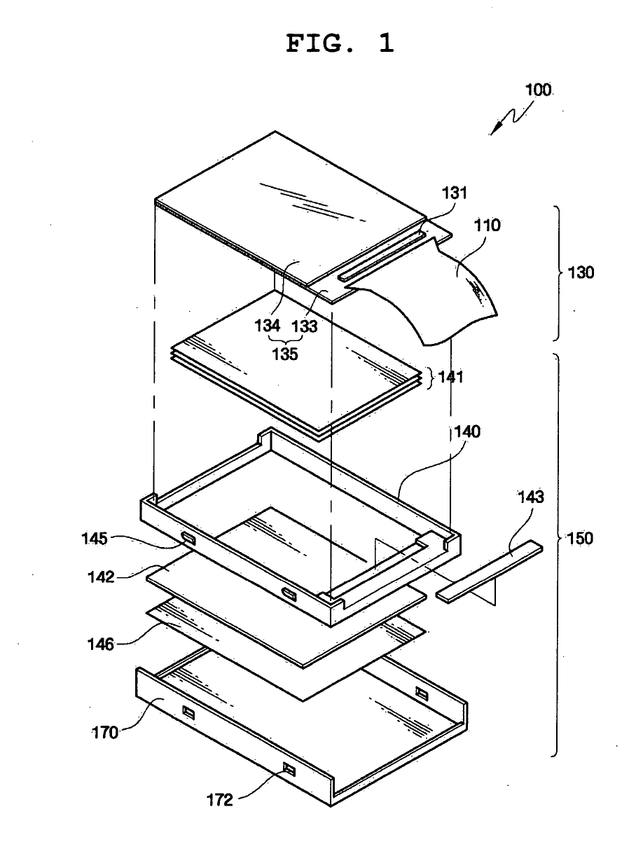

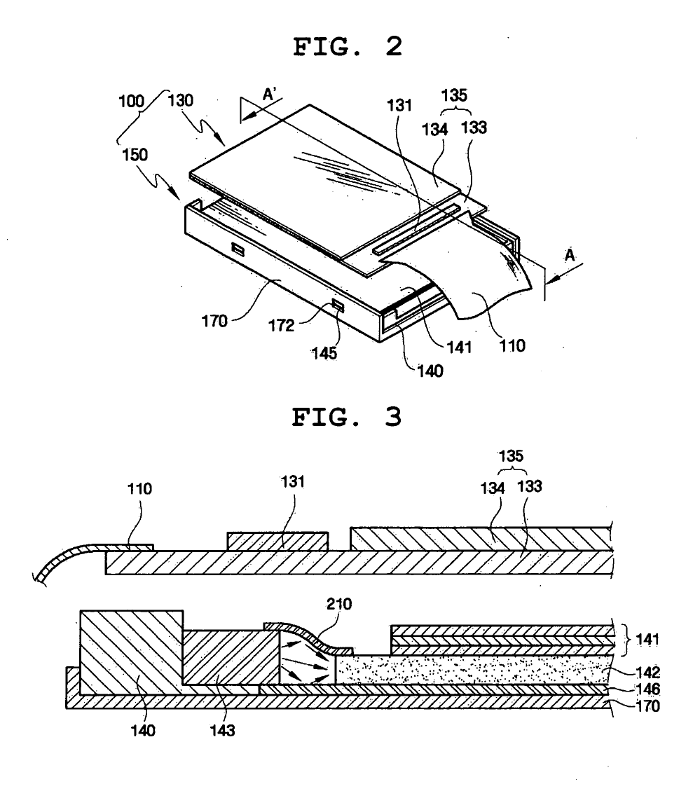

FIG. 1 is an exploded perspective view of a liquid crystal display (LCD) according to an embodiment of the present invention; FIG. 2 is a perspective view of the LCD of FIG. 1 after assembly; and FIG. 3 is a cross-sectional view taken along line A-A′ of FIG. 2.

Referring to FIGS. 1 through 3, the LCD 100 includes a liquid crystal panel assembly 130 and a backlight assembly 150.

Here, the liquid crystal panel assembly 130 includes a liquid crystal panel 135 having a TFT panel 133 and a color filter panel 134, a liquid crystal (not shown), a driving IC 131, and a flexible printed circuit board (FPCB) 110.

The liquid crystal panel 135 is a device which displays image information such as a character, a number, or an arbitrary icon by adjusting the transmissivity of light that passes through a liquid crystal layer (not shown) according to the intensity of an applied voltage. The liquid crystal panel 135 includes the TFT panel 133, the color filter panel 134, and the liquid crystal (not shown).

The TFT panel 133 includes a plurality of gate lines, a data line, and a pixel electrode. The gate lines extend in a row direction and transmit a gate signal. The data line extends in a substantially perpendicular column direction and transmits a data signal. A pixel is connected to the gate lines and the data line and includes a switching element and a sustain capacitor.

Here, the switching element is formed at a cross-point of the gate line and the data line, and the sustain capacitor and a liquid crystal capacitor are connected to an output terminal of the switching element. In addition, the switching element is formed as a TFT using amorphous silicon and poly-silicon as a channel layer.

Another terminal of the sustain capacitor is connected to a common voltage or the gate line directly formed on the sustain capacitor. Here, the former connection type is a separate wire type, and the latter connection type is a previous gate type.

The color filter panel 134 is located on the TFT panel 133 and includes a color filter that represents red, green, or blue color in a region corresponding to the pixel electrode so as to display color in each pixel. Here, the color filter may be formed above or below the pixel electrode. In addition, a common electrode formed of a transparent conductive material such as indium tin oxide (ITO) or indium zinc oxide (IZO) is formed on the color filter.

The liquid crystal layer (not shown) is filled between the color filter panel 134 and the TFT panel 133 and has dielectric anisotropy. The thickness of the liquid crystal layer is about 5 micrometers, and the liquid crystal layer is twisted nematic (TN) arranged. The arrangement direction of the liquid crystal layer is changed by a voltage applied from the outside so that the transmissivity of light passing through the liquid crystal layer is adjusted.

The TFT panel 133, the color filter panel 134, and the liquid crystal layer (not shown), which are elements for the liquid crystal panel 135, constitute a liquid crystal capacitor. The liquid crystal capacitor having the above structure is connected to the output terminal of the switching element and the common voltage or a reference voltage.

The driving IC 131 is an integrated circuit (IC) which receives a gate control signal, a data control signal, and a data signal related to the data control signal from the FPCB 110 via an input terminal and provides a gate driving signal and a data driving signal to the gate line and the data line formed on the TFT panel 133 via an output terminal. As such, a desired image can be formed on the liquid crystal panel 135.

The driving IC 131 is mounted on the TFT substrate 133 other than an image display region corresponding to the color filter panel 134 of the TFT panel 133 so that an output terminal of the driving IC 131 is connected to each of the gate line and the data line that extend from the image display region using chip on glass (COG) techniques. As descried above, the gate driving signal and the data driving signal generated by the driving IC 131 are transmitted to each pixel formed in the image display region of the TFT panel 133.

The FPCB 110 is a kind of PCB which connects various electronic components to a printed circuit original board or supports the electronic components according to the circuit design of electric wires. The FPCB 110 is flexible unlike a conventional PCB. The FPCB 110 includes a base film, terminal regions in which metallic sheet patterns are arranged as lead terminals at both ends of the base film, and an interface region in which the metallic sheet patterns are formed as electric wires so that the terminal regions arranged at both ends of the base film are connected to each other and in which a coverlay or protection layer is formed for protection and insulation of the electric wires. In addition, a plurality of through holes may be formed in the interface region, and the FPCB 110 may further include a region in which the mounted electronic components are connected to the electric wires through the through holes and a predetermined electronic circuit is formed.

One end of the FPCB 110 is connected to an external PCB (not shown), and the other end thereof is connected to an input terminal of the driving IC 131. As such, the gate driving signal, the data driving signal, and the data signal related to the data driving signal are transmitted to the driving IC 131 from the external PCB.

The backlight assembly 150 according to an embodiment of the present invention includes optical sheets 141, a lamp assembly 143, a light guide film 142, a reflection sheet 146, an upper receiving container 140 receiving them, and a lower receiving container 170 combined with the upper receiving container 140.

Here, the light guide film 142 guides light emitted from the lamp assembly 143. That is, the light guide film 142 allows the light generated in the lamp assembly 143 to proceed in a direction of the liquid crystal panel 135 seated on the light guide film 142. Thus, a variety of patterns for changing the proceeding direction of the light incident into the light guide film 142 into the direction of the liquid crystal panel 135 may be printed and formed at a rear side of the light guide film 142. Alternatively, a rigid light guide panel instead of the light guide film 142 may be used. Here, a material for the light guide film 142 or the light guide panel may be properly selected, for example, polymethylmethacrylate (PMMA), polycarbonate (PC), polyethylene (PE), or polyethylene terephthalate (PET). The light guide film 142 or the light guide panel is formed to a smaller thickness than the lamp assembly 143 so that the thickness of the LCD can be reduced. For the convenience of explanation, the present invention will now be described with respect to the light guide film.

The lamp assembly 143 is a member for providing light to the LCD 100 which is a non-emission element, and is inserted into one side of the light guide film 142 in the upper receiving container 140. The lamp assembly 143 includes a light source and a light source cover. A lamp for use in the lamp assembly 143 may include a light emitting diode (LED), a cold cathode fluorescent lamp (CCFL), a hot cathode fluorescent lamp (HCFL), or an external electrode fluorescent lamp (EEFL). The lamp assembly 143 may include a plurality of point sources of light or line sources of light.

As shown in FIG. 3, when the light guide film 142 having a smaller thickness than the lamp assembly 143 is used, a light guide such as a reflection cover 210 covers an upper portion of an air gap between the lamp assembly 143 and the light guide film 142 so as to prevent loss of light emitted from the lamp assembly 143. The reflection cover 210 reflects the light emitted in an upward direction from the lamp assembly 143 into the light guide film 142. For example, a film coated with Ag or a Vikuiti™ enhanced specular reflector (ESR) manufactured by 3M™ may be used as the reflection cover 210.

The reflection sheet 146 is installed at a lower side of the light guide film 142 and reflects light emitted from a lower portion of the lamp assembly 143 in an upward direction. The reflection sheet 146 reflects the light that is not reflectedby fine dot patterns formed at the rear side of the light guide film 142 into the emission side of the light guide film 142 so that loss of light incident into the liquid crystal panel 135 can be reduced and the uniformity of light transmitted to the emission side of the light guide film 142 can be improved. The reflection sheet 146 extends to the lower portion of the lamp assembly 143 from the lower side of the light guide film 142, thereby suppressing a light leakage between the lamp assembly 143 and the light guide film 142.

By providing the reflection cover 210 and the reflection sheet 146, a light leakage can be prevented from occurring due to a difference in thickness between the lamp assembly 143 and the light guide film 142. That is, the light emitted from the lamp assembly 143 in a downward direction is guided by the reflection sheet 146 to the light guide film 142, and the light emitted from the lamp assembly 143 in an upward direction is guided by the reflection cover 210 to the light guide film 142.

The optical sheets 141 are seated on the upper side of the light guide film 142 and used to diffuse and condense light transmitted from the light guide film 142. The optical sheets 141 may include a diffusion sheet, a prism sheet, a protective sheet, and the like, in one example.

The diffusion sheet placed between the light guide film 142 and the prism sheet is used to disperse the light emitted from the light guide film 142 and to prevent light from being partially crowed. The prism sheet is formed in such a way that a trigonal prism is formed in a predetermined arrangement at the upper side of the prism sheet. The prism sheet generally includes two sheets and is used to condense light diffused from the diffusion sheet when each prism arrangement is disposed to cross each other at a predetermined angle, in a direction perpendicular to the liquid crystal panel 135. As such, most of the light that passes through the prism sheet proceeds in a horizontal direction and brightness is uniformly distributed on the protective sheet. The protective sheet formed on the prism sheet is used to protect the surface of the prism sheet and to diffuse light so as to make the diffusion of light uniform. In addition, a black line (not shown) may be formed along an edge of the protective sheet so as to prevent the formation of a bright line or leakage of light that occurs at an edge of a display region of the liquid crystal panel 135.

Here, in the case of the small-sized LCD 100, one lamp is generally installed at a side of the light guide film 142. As the LCD 100 grows larger, a plurality of lamps may be installed in one lamp assembly 143 so as to obtain sufficient brightness.

The liquid crystal panel assembly 130 is installed on the optical sheets 141 and seated on the light guide film 142 together with the optical sheets 141.

A sidewall of the upper receiving container 140 is formed along an edge of a rectangular opening and a predetermined protrusion (not shown) is formed in the sidewall so that the upper receiving container 140 receives and fixes the liquid crystal panel assembly 130, the optical sheets 141, the lamp assembly 143, the light guide film 142, and the reflection sheet 146 and prevents the plurality of sheets from being bent. The FPCB 110 of the liquid crystal panel assembly 130 is bent centering on one sidewall of the upper receiving container 140. Here, the upper receiving container 140 may be formed in a variety of shapes according to a method of receiving the liquid crystal panel assembly 130, the optical sheets 141, the lamp assembly 143, the light guide film 142, and the reflection sheet 146.

The upper receiving container 140 can be hook-coupled to the lower receiving container 170. For example, a hook 145 may be formed along an outer side of the sidewall of the upper receiving container 140, and a hook insertion hole 172 corresponding to the hook 145 may be formed at a side of the lower receiving container 170. Thus, the lower receiving container 170 is aligned with the lower portion of the upper receiving container 140 so that the hook 145 formed in the upper receiving container 140 is inserted into the hook insertion hole 172 of the lower receiving container 170 and the upper receiving container 140 and the lower receiving container 170 is combined with each other. The present invention is not limited to this example, and alternatively, a hook may be located at the lower receiving container 170 and a hook insertion hole may be formed in the upper receiving container 140. In addition, the upper receiving container 140 and the lower receiving container 170 may be coupled to each other by various means and methods.

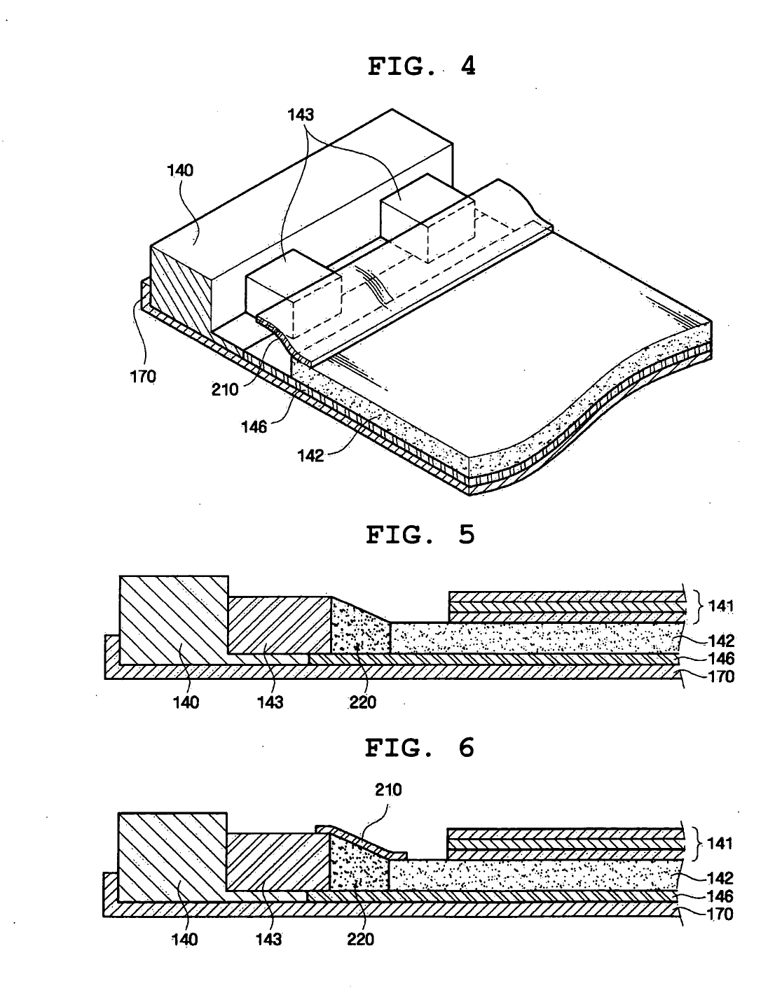

As described above, the lamp for use in the lamp assembly 143 may include a plurality of point sources of light, for example, LEDs. FIG. 4 is a perspective view of the lamp assembly 143 having the plurality of point sources of light, the light guide film 142, and the reflection cover 210. Even in this case, the reflection cover 210 can effectively guide the light emitted from the lamp assembly 143 to the light guide film 142.

A backlight assembly according to another embodiment of the present invention will now be described with reference to FIG. 5. FIG. 5 is a cross-sectional view of a backlight assembly according to another embodiment of the present invention.

For the convenience of explanation, components each having the same function for describing the embodiments shown in FIGS. 1 through4 are respectively identified by the same reference numerals, and their repetitive description will be omitted. The backlight assembly of FIG. 5 basically has the same structure as that shown in FIGS. 1 through 4 except for the following. That is, as shown in FIG. 5, instead of the reflection cover so as to reduce loss of the light emitted from the lamp assembly 143, the light guide includes a light guide gel 220 interposed in an air gap between the lamp assembly 143 and the light guide film 142.

The light emitted from the lamp assembly 143 passes through the light guide gel 220 and may be guided to the light guide film 142. Here, thelight guide gel 220 uses a material having a refractive index similar to the light guide film 142 so that light loss can be minimized. Further, it is preferable that the light guide gel 220 has substantially the same refractive index as the light guide film 142. In addition, the light guidege 122 having a predetermined coefficient of viscosity may be used so that the light guide gel 220 can be smoothly filled between the lamp assembly 143 and the light guide film 142. The light guide gel 220 having a predetermined coefficient of viscosity is not easily deviated even by external shock. The light guide gel 220 may use a light-guiding acryl material, for example. As shown in FIG. 5, the light guide gel 220 that connects the lamp assembly 143 and the light guide film 142 having different thicknesses has an inclined section from the lamp assembly 143 to the light guide film 142. For example, the light guide gel 220 may have a rectangular section.

Further, in order to improve the uniformity of light that passes through the light guide gel 220 from the lamp assembly 143, a diffuser can be added to the light guide gel 220. A plurality of particulates formed of polymethylmethacrylate (PMMA), polycarbonate (PC), polyethylene (PE), polyethylene terephthalate (PET), or cyclo olefin polymer (COP) and having a particle size of about 5-20 nm can be used as the diffuser. The diffuser may be properly distributed in the light guide gel 220. When a very small amount of the diffuser is distributed in the light guide gel 220, the uniformity of light may be lowered, and when a very large amount of the diffuser is distributed in the light guide gel 220, the uniformity of light is improved but light is dispersed by the diffuser and loss of light increases.

In addition, when the lamp assembly 143 having the plurality of point sources of light is used, a larger amount of the diffuser may be distributed at a location corresponding to each point source of light in the light guide gel 220 so that the uniformity of light can be improved.

A backlight assembly according to another embodiment of the present invention will now be described with reference to FIG. 6. FIG. 6 is a cross-sectional view of a backlight assembly according to another embodiment of the present invention.

As shown in FIG. 6, the backlight assembly is characterized by the structure in which a light guide includes the reflection cover 210 covering the light guide gel 220 interposed between the lamp assembly 143 and the light guide film 142. In the backlight assembly of FIG. 6, loss of light can be further reduced than in the backlight assembly of FIG. 5. That is, the light emitted from the lamp assembly 143 is basically guided by the light guide gel 220 to the light guide film 142, and additionally, the light emitted from the top side of the light guide gel 220 is reflected into the light guide gel 220 by the reflection cover 210 so that light loss can be minimized.

As described above, in the LCD according to the present invention, a wedge type backlight assembly having a lamp assembly at one side of a light guide film can be used as an example, and a flat type backlight assembly having the lamp assembly at both sides of the light guide film having a flat plane can be applied.

In addition, while an edge type backlight assembly having a lamp at a side of the light guide film has been illustrated by way of example, the invention can be applied to a direct-type backlight assembly in which the light guide film is not provided and a plurality of lamps are arranged at a bottom surface.

As described above, with the backlight assembly and the LCD having the same according to the present invention, a lighter, thinner, shorter and smaller LCD can be attained while minimizing light loss.

While the present invention has been particularly shown and described with reference to exemplary embodiments thereof, it will be understood by those skilled in the art that various changes in form and details may be made therein without departing from the spirit and scope of the invention as defined by the following claims and equivalents thereof.

What is claimed is:

1. A backlight assembly, comprising:
a lamp assembly providing light to a liquid crystal panel;
a light guide film for guiding the light emitted from the lamp assembly;
a light guide for guiding light emitted from the lamp assembly to the light guide film through a gap therebetween;
optical sheets stacked on the light guide film, the optical sheets for diffusing and condensing the light emitted from the light guide film; and
upper and lower receiving containers for receiving the lamp assembly, the light guide film, and the optical sheets.

2. The backlight assembly of claim 1, wherein the light guide includes a light guide gel interposed in the gap.

3. The backlight assembly of claim 2, wherein the light guide gel has substantially the same refractive index as the light guide film.

4. The backlight assembly of claim 2, wherein the lamp assembly and the light guide film are formed to different thicknesses.

5. The backlight assembly of claim 4, wherein the light guide gel has an inclined section from the lamp assembly to the light guide film.

6. The backlight assembly of claim 2, wherein the light guide gel is formed of a light-guiding acryl material.

7. The backlight assembly of claim 2, further comprising a diffuser distributed in the light guide gel for improving uniformity of light that passes through the light guide gel.

8. The backlight assembly of claim 7, wherein the diffuser is formed of polymethylmethacrylate (PMMA), polycarbonate (PC), polyethylene terephthalate (PET), or cyclo olefin polymer (COP).

9. The backlight assembly of claim 7, wherein the diffuser is formed of a plurality of particulates having a size in a range of about 5 to about 20 nm.

10. The backlight assembly of claim 2, wherein the light guide film is flexible and is formed of polymethylmethacrylate (PMMA), polycarbonate (PC), polyethylene (PE), or polyethylene terephthalate (PET).

11. The backlight assembly of claim 1, wherein the light guide includes a reflection cover covering an upper portion of the gap between the lamp assembly and the light guide film for reflecting light emitted from the lamp assembly into the light guide film.

12. The backlight assembly of claim 11, wherein the reflection cover is formed of a film coated with Ag.

13. The backlight assembly of claim 11, wherein the reflection cover is formed of a Vikuiti™ enhanced specular reflector (ESR).

14. The backlight assembly of claim 11, further comprising a reflection sheet extending in a lower portion of the lamp assembly from a lower side of the light guide film and reflecting the light in an upward direction.

15. A backlight assembly, comprising:
a lamp assembly providing light to a liquid crystal panel;
a light guide film for guiding the light emitted from the lamp assembly;
a light guide gel interposed in a gap between the lamp assembly and the light guide panel for guiding the light emitted from the lamp assembly to the light guide panel;
a reflection cover covering an upper portion of the light guide gel for reflecting light emitted from the lamp assembly into the light guide panel;
optical sheets stacked on the light guide panel for diffusing and condensing the light emitted from the light guide film; and
upper and lower receiving containers for receiving the lamp assembly, the light guide panel, and the optical sheets.

16. The backlight assembly of claim 15, wherein the light guide gel has substantially the same refractive index as the light guide film.

17. The backlight assembly of claim 15, wherein the lamp assembly and the light guide film are formed to different thicknesses.

18. The backlight assembly of claim 15, wherein the light guide gel has an inclined section from the lamp assembly to the light guide film.

19. The backlight assembly of claim 15, wherein the light guide gel is formed of a light-guiding acryl material.

20. The backlight assembly of claim 15, further comprising a diffuser distributed in the light guide gel for improving uniformity of light that passes through the light guide gel.

21. The backlight assembly of claim 20, wherein the diffuser is formed of polymethylmethacrylate (PMMA), polycarbonate (PC), polyethylene terephthalate (PET), or cyclo olefin polymer (COP).

22. The backlight assembly of claim 20, wherein the diffuser is formed of a plurality of particulates having a size in the range from about 5 nm to about 20 nm.

23. The backlight assembly of claim 15, wherein the light guide film is flexible and is formed of polymethylmethacrylate (PMMA), polycarbonate (PC), polyethylene (PE), or polyethylene terephthalate (PET).

24. A liquid crystal display, comprising:
a liquid crystal panel assembly displaying image information; and
a backlight assembly for providing light to the liquid crystal panel assembly, the backlight assembly comprising:
a lamp assembly providing light to a liquid crystal panel;
a light guide film for guiding the light emitted from the lamp assembly;
a light guide for guiding light emitted from the lamp assembly to the light guide film through a gap therebetween;
optical sheets stacked on the light guide film, the optical sheets for diffusing and condensing the light emitted from the light guide film; and
upper and lower receiving containers for receiving the lamp assembly, the light guide film, and the optical sheets.
